(19) United States
(12) Patent Application Publication
(10) Pub. No.: US 2016/0090883 A1
(43) Pub. Date: Mar. 31, 2016

(54) BREATHER APPARATUS

(71) Applicant: FUJI JUKOGYO KABUSHIKI KAISHA, Tokyo (JP)

(72) Inventors: Toshihiro NISHIGUCHI, Tokyo (JP); Osamu MORI, Tokyo (JP); Takamichi MATSUKI, Tokyo (JP); Shogo SAKURAI, Tokyo (JP); Kosuke TSUCHIYA, Tokyo (JP); Tatsuya TSUJI, Tokyo (JP); Masakazu OHI, Tokyo (JP)

(73) Assignee: FUJI JUKOGYO KABUSHIKI KAISHA, Tokyo (JP)

(21) Appl. No.: 14/850,237

(22) Filed: Sep. 10, 2015

(30) Foreign Application Priority Data
Sep. 26, 2014 (JP) 2014-196555

(51) Int. Cl. F01M 13/04; F02M 25/06

(52) U.S. Cl. CPC F01M 13/0416; F02M 25/06

(57) ABSTRACT

A breather apparatus is provided in a cylinder head having an intake camshaft and an exhaust camshaft that drive an intake valve and an exhaust valve, respectively. The breather apparatus includes, spaces separated from each other by partition walls and in communication with each other through an opening formed in the partition walls, the spaces having a blow-by gas flowing from a crankcase side passing sequentially therethrough. The spaces include a first space and a second space. The first space is formed in a region between the intake valve and the exhaust valve in the cylinder head. The second space is provided across the first space from a crankcase side, separated from the first space by a partition wall disposed substantially along a plane including shaft centers of the intake camshaft and the exhaust camshaft, and receives the blow-by gas flowing from the first space.

### CROSS-REFERENCE TO RELATED APPLICATIONS

The present application claims priority from Japanese Patent Application No. 2014-196555 filed on Sep. 26, 2014, the entire contents of which are hereby incorporated by reference.

### BACKGROUND

1. Technical Field

The present invention relates to a breather apparatus that is installed on a cylinder head of an engine that subjects a blow-by gas to vapor-liquid separation, before discharging and, more particularly, to a breather apparatus that provides good vapor-liquid separation with a suppressed projection from the cylinder head.

2. Related Art

A four-stroke engine installed on a vehicle such as an all-terrain vehicle (ATV) is provided with a breather apparatus (or oil separator) that separates oil from an oil-mist containing blow-by gas accumulated in the engine before discharging the gas.

Such a breather apparatus typically performs vapor-liquid separation treatment in which a blow-by gas, while being passed sequentially through a plurality of spaces in communication with each other, is treated through the use of a labyrinthine structure and a change in gas flow rate.

For an engine having a cylinder projecting upward from a crankcase, a breather apparatus is typically mounted to extend through a cam cover on top of a cylinder head.

As such a breather apparatus, for instance, Japanese Patent No. 4075059 discloses a breather apparatus including a plurality of spaces integrally formed in part of a cam cover on top of a cylinder head.

Also, WO2008/056831 describes a technique for introducing a blow-by gas into an oil separator provided in the lower to upper portions of a valve train chamber in a double overhead camshaft (DOHC) engine.

### SUMMARY OF THE INVENTION

Unfortunately, however, if a breather apparatus of the related art is provided on top of a cylinder head, an oil separator (of spaces) may project upward from the cam cover of the cylinder head.

If the number and capacity of the spaces are increased to improve vapor-liquid separation, the upward projection of the oil separator from the cam cover may increase.

In consideration of installation on ATVs or other assemblies, it is desirable to minimize the projection of the breather apparatus from the cylinder head for easier installation and to avoid interference with the vehicle body or other components.

It is desirable to provide a breather apparatus that has a good vapor-liquid separation performance with a suppressed projection from a cylinder head.

A first aspect of the present invention provides a breather apparatus that is provided in a cylinder head having an intake camshaft and an exhaust camshaft that drive an intake valve and an exhaust valve, respectively. The breather apparatus has spaces separated from each other by partition walls and in communication with each other through an opening formed in the partition walls, the spaces having a blow-by gas flowing from a crankcase side passing sequentially therethrough. The spaces include a first space formed in a region between the intake valve and the exhaust valve in the cylinder head and a second space that is provided across the first space from a crankcase side, separated from the first space by a partition wall disposed substantially along a plane including shaft centers of the intake camshaft and the exhaust camshaft, and receives the blow-by gas flowing from the first space.

Part of a lifter that may drive the intake valve and part of a lifter that may drive the exhaust valve may project into the first space.

The second space may be provided inside a cam cover that is installed or the cylinder head and constitutes part of an intake cam chamber that houses the intake camshaft and an exhaust cam chamber that houses the exhaust camshaft.

The breather apparatus described in the third aspect may include a third space into which the blow-by gas from the second space flows, the third space projecting from an outer surface of the cam cover.

### BRIEF DESCRIPTION OF THE DRAWINGS

FIG. 1 is a view of a cylinder head having a breather apparatus according to an example of the present invention, as seen from an axis line of a cylinder.

FIG. 2 is a sectional view taken from II of FIG. 1.

FIG. 3 is a sectional view taken along the line III-III of FIG. 1.

FIG. 4 is a sectional view taken along the line IV-IV of FIG. 1.

FIG. 5 is a sectional view taken along the line V-V of FIG. 2.

FIG. 6 is a sectional view taken along the line VI-VI of FIG. 2.

### DETAILED DESCRIPTION

To provide a breather apparatus with good vapor-liquid separation performance and a suppressed projection from a cylinder head, a space inside a cylinder head of a DOHC engine is partitioned by a partition wall formed substantially along a plane including the central axes of an intake camshaft and an exhaust camshaft, and its upper and lower spaces are used as first and second spaces through which a blow-by gas is sequentially passed.

### EXAMPLE

An example of a breather apparatus according to the present invention is described below.

A breather apparatus according to the example is installed in a cylinder head of a water-cooled, four-stroke, single-cylinder, DOHC, gasoline engine used as a power source for a vehicle such as, but not limited to, ATV.

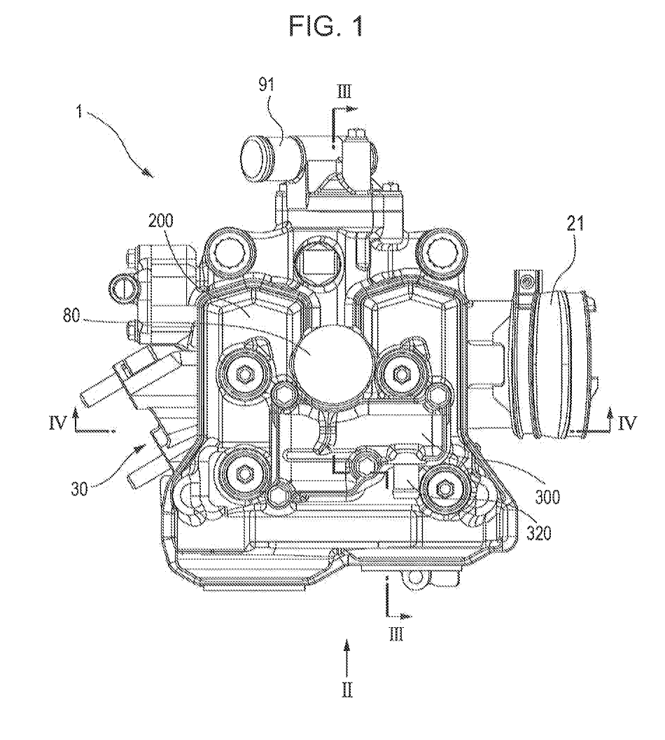

FIG. 1 is a view of a cylinder head having a breather apparatus according to the example of the present invention, as seen from an axis line of a cylinder.

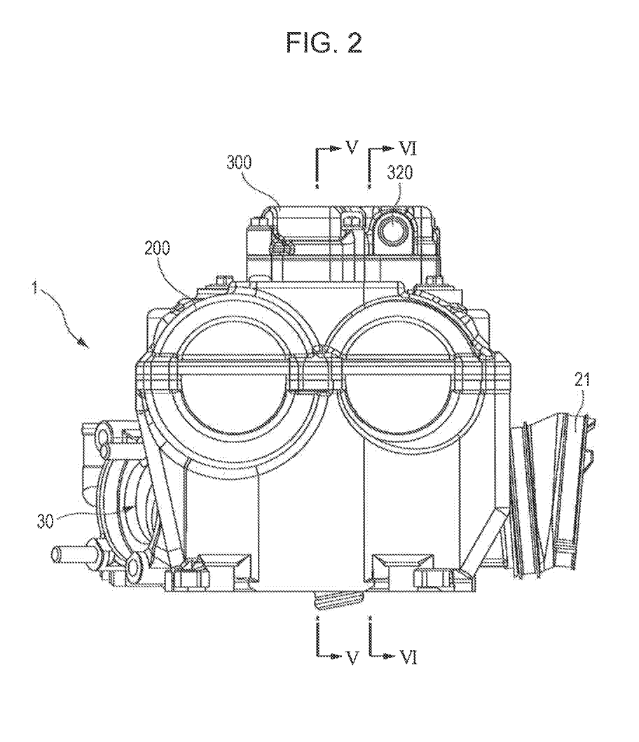

FIG. 2 is a sectional view taken from II of FIG. 1.

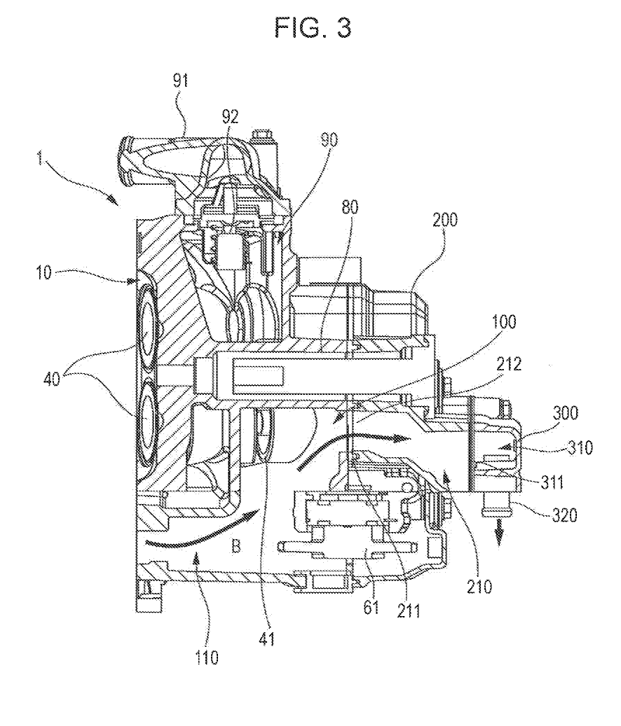

FIG. 3 is a sectional view of FIG. 1 along the line III-III.

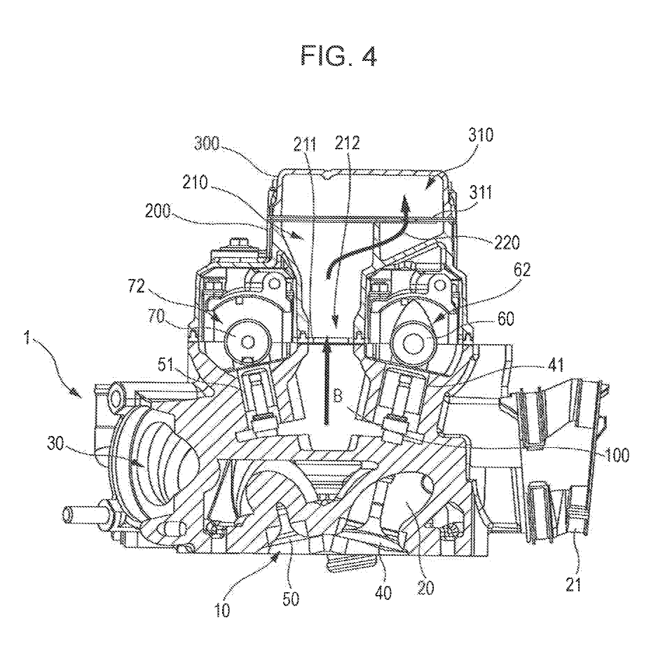

FIG. 4 is a sectional view of FIG. 1 along the line IV-IV.

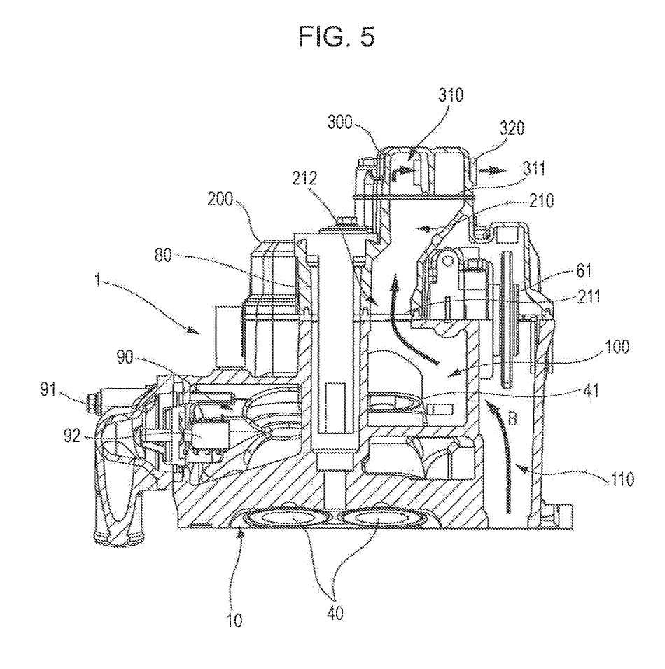

FIG. 5 is a sectional view of FIG. 2 along the line V-V.

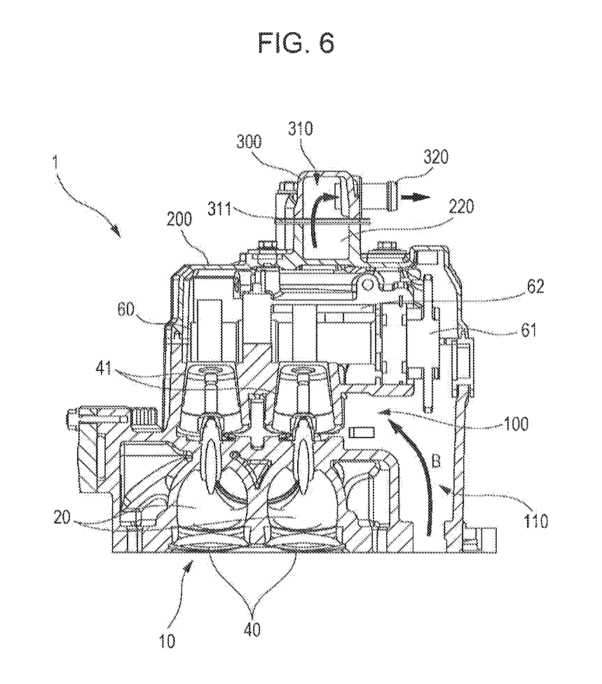

FIG. 6 is a sectional view of FIG. 2 along the line VI-VI.

A cylinder head 1 is provided at an end across a cylinder (not illustrated) from a crankcase side.

The cylinder head 1 is formed by subjecting, for instance, a forged aluminum alloy to a predetermined machining process.

The cylinder head 1 has a combustion chamber 10, an intake port 20, an exhaust port 30, an intake valve 40, an exhaust valve 50, an intake camshaft 60, an exhaust camshaft 70, a spark plug mounting portion 80, a water jacket 90, a space 100, a chain chamber 110, and the like.

The combustion chamber 10 is a recess formed in the shape of a pent roof in a cylinder-side surface (bottom surface) of the cylinder head 1.

The intake port 20 is a passage through which an air-fuel mixture is introduced, into the combustion chamber 10.

An upstream (inlet-side) end of the intake port 20 is opened to a side surface of the cylinder head 1 and connected to an intake system (not illustrated) having an air cleaner, a throttle, and a carburetor through an insulator 21 made of resin that suppresses heat transmission from the cylinder head 1 to other components.

A downstream (outlet-side) end of the intake port 20 is bifurcated and opened to one slanted roof of the pent-roof-shaped combustion chamber 10.

The exhaust port 30 is a passage through which a combustion gas (exhaust gas emission) is discharged from the combustion chamber 10 to the outside.

An upstream end of the exhaust port 30 is bifurcated into two and opened to the other slanted roof of the pent-roof-shaped combustion chamber 10.

A downstream end of the exhaust port 30 is opened to an end on the opposite side of the intake port 20 of the cylinder head 1 and connected to an exhaust system (not illustrated) having an exhaust pipe, a silencer, and an exhaust-gas after-treatment device.

The intake valve 40 and the exhaust valve 50 open/close the ends of the intake port 20 and the exhaust port 30, respectively, on the side of the combustion chamber 10 at predetermined valve timing.

The intake valve 40 and the exhaust valve 50 have a cylindrical-shaped stem with an umbrella-shaped valve formed, at its end on the side of the combustion chamber 10.

Two of the intake valves 40 are arranged in such a manner that they are spaced apart from each other along the axis line of the crankshaft and their stems are parallel to each other. This is the case with the exhaust valve 50 as well.

The intake valve 40 and the exhaust valve 50 are inclined at a predetermined valve-inclined-angle in such a manner that the ends of their stems on the side of the cam cover 200 are expanded compared with the other ends on the side of the combustion chamber 10.

The stems of the intake valve 40 and the exhaust valve 50 are inserted into a cylindrical-shaped stem guide pressed into the cylinder head 1 and are capable of reciprocating movement along the axial direction of the stem against the cylinder head 1.

The intake valve 40 and the exhaust valve 50 are provided at their stem ends on the side of the camshaft with lifters 41, 51 that transmit driving power from an intake camshaft 60 and an exhaust camshaft 70.

The lifters 41, 51 are formed in the shape of a cup so as to have an end surface in slidable contact with the cam at an upper end of their cylindrical-shaped roll-like body.

The stem ends of the intake valve 40 and the exhaust valve 50 are inserted into the lifters 41, 51, respectively, and are disposed so as to be opposed to the surface on the opposite side of the cam-side end.

The intake camshaft 60 and the exhaust camshaft 70 are rotated at a revolutions per minute (rotational speed) half that of the crankshaft and in synchronization with the crankshaft (not illustrated) that is an output shaft of the engine and opens/closes the intake valve 40 and the exhaust valve 50, respectively, at a predetermined valve timing.

The intake camshaft 60 and the exhaust camshaft 70 are supported by a bearing disposed in the cylinder head 1 and a cam support fastened to the cylinder head 1 so as to be rotatable in relation to the cylinder head 1.

The intake camshaft 60 and the exhaust camshaft 70 have an oil hole formed at a center thereof, through which lubricating oil pressurized by an oil pump (not illustrated) is supplied.

The lubricating oil supplied through the oil hole is distributed to a journal (shaft portion) of the camshaft.

The intake camshaft 60 and the exhaust camshaft 70 are disposed so as to be parallel to the crankshaft (not illustrated) at a predetermined distance to the crankshaft.

The intake camshaft 60 and the exhaust camshaft 70 are provided at one end thereof with cam sprockets 61, 71, respectively.

The cam sprockets 61, 71 have a timing chain therearound which transmits power from the crank sprocket of the crankshaft (not illustrated).

The intake camshaft 60 and the exhaust camshaft 70 are housed in an intake cam chamber 62 and an exhaust cam chamber 72, respectively, that include a cylindrical-shaped space.

The intake cam chamber 62 and the exhaust cam chamber 72 have one-half on the crankcase side formed integrally with the cylinder head 1 and have the other half formed integrally with a cam cover 200 to be described later.

The spark plug mounting portion 80 is a portion to which a spark plug (not illustrated) that generates a spark in the combustion chamber 10 at a predetermined ignition timing is fastened.

The spark plug mounting portion 80 is substantially cylindrical-shaped and arranged substantially coaxially with a central axis of the cylinder.

The spark plug mounting portion 80 is disposed substantially in the center of the intake valve 40 and the exhaust valve 50, these valves totaling four, and the end of the spark plug mounting portion 80 on the side of the cam cover 200 is disposed between the intake camshaft 60 and the exhaust camshaft 70.

The water jacket 90 forms a space inside the cylinder head 1 through which a coolant pressure-fed by a crankshaft-driven pump is passed.

The water jacket 90 is formed around the combustion chamber 10 and the exhaust port 30.

The coolant is introduced into the space inside the water jacket 90 through a thermostat 92 whose valve opens at high temperatures from an inlet 91 that is provided on a side surface of the cylinder head 1 and is connected to the water pump via a hose.

The space 100 is a space formed between the intake valve 40 and the exhaust valve 50 in the cylinder head 1 so as to be disposed around the spark plug mounting portion 80.

The space 100 is in communication with a chain chamber 110 in which the timing chain is housed and has an oil-mist containing blow-by gas introduced through the chain chamber 110 from the crankcase.

The lifters 51 on the intake/exhaust side are provided so as to partly project into the space 100.

The chain chamber 110 is a space for housing a timing chain, a part of which is disposed in the cylinder head 1 on the side of the cam sprockets 61, 71 and is in communication with the crankcase.

The cylinder head 1 has a cam cover 200 and an oil separator 300 provided thereon.

The cam cover 200 is a lid-like component that substantially blocks an opening across the cylinder head 1 from the crankcase side.

The cam cover 200 houses the halves of the intake cam chamber 62 and the exhaust cam chamber 72 on the opposite side of the crankcase side, and spaces 210, 220 therein.

The space 210 is formed between the intake cam chamber 62 and the exhaust cam chamber 72 in the cam cover 200.

The space 210 is defined by a space 100 of the cylinder head 1 and a partition wall 211 and is in communication with the space 100 through an opening 212 formed in the partition wall 211.

The partition wall 211 is a plate-like member formed substantially along a plane including the central axes of the intake camshaft 60 and the exhaust camshaft 70 and is held between the cylinder head 1 and the cam cover 200.

The partition wall 211 is part of a gasket that seals a gap between the cylinder head 1 and the cam cover 200 and is formed integrally with the gasket.

A blow-by gas flows into the space 210 through the opening 212.

The space 220 is formed adjacent to a region (directly above the intake cam chamber 62 in engines having a cylinder arranged vertically) across the intake cam chamber 62 from the crankcase side.

The space 220 is in communication with the space 210 through an opening formed in a partition wall between the spaces 220, 210.

The blow-by gas flows into the space 220 through the space 210.

The oil separator 300 is a box-like member that projects from a surface (upper surface) of the cam cover 200 on the opposite side of the crankcase side.

A space 310 is formed inside the oil separator 300.

The space 310 is defined by the space 220 of the cam cover 200 and the partition wall 311 and is in communication with the space 220 through an opening (not illustrated) formed in the partition wall 311. Such an opening may be provided with a check valve that prevents reverse flow of the blow-by gas.

A blow-by gas B flows into the space 310 through the space 220.

After entering the space 310, the blow-by gas B is introduced into an intake pipe for combustion treatment through a discharge pipe 320 and a hose connected to the discharge pipe 320.

The blow-by gas B has been substantially cleared of an oil mist when discharged through the discharge pipe 320.

In a cylinder head 1 described above, the spaces 100, 210, 220, 310 constitute a breather apparatus that subjects the blow-by gas B to a vapor-liquid separation treatment.

While sequentially passing through the spaces 100, 210, 210, 310, the blow-by gas B undergoes a change in gas flow rate and a complicated flow passage structure (labyrinthine structure) and is purged of an oil mist.

The purged oil flows down walls in the spaces and returns to the crankcase side.

As described above, this example provides the following advantages.

(1) The space 100 inside the cylinder head 1 and the space 210 inside the cam cover 200 are in communication with each other, through which the blow-by gas is sequentially passed. With this arrangement, the spaces inside the cylinder head 1 can be used as at least two breather spaces to treat a blow-by gas, thereby reducing the number and capacity of spaces projecting toward the outside of the cam cover 200.

This provides a good vapor-liquid separation with a suppressed projection from the cylinder head 1. In particular, since the capacity of the space 100 can be relatively enlarged by using a region that has conventionally been treated as a dead space in the cylinder head 1, the flow rate of the blow-by gas B can be effectively reduced with a change in volume given to the downstream spaces 210, 220, 310.

Also, the installation of the partition wall 211 strengthens the oil bath structure (oil storage capacity) of the intake cam chamber 62 and the exhaust cam chamber 72, thereby providing an advantage of suppressing cam wear.

(2) The lifters 41, 51 exposed to the space 100 generate a pulsation (pumping action) in the space 100 during their reciprocating movement, which activates a gas flow in the space 100, thereby improving breather performance.

(3) The space 210 in the cam cover 200 allows the second space receiving a blow-by gas from the space 100 to have a simplified structure.

(4) A blow-by gas flow into the oil separator 300 through the spaces 210, 220 in the cam cover 200 allows the capacity of the space 310 of the oil separator 300 projecting to the outside of the cam cover 200 to be minimized, thereby minimizing the projection from the cam cover 200.

(Modification)

Needless to say, the present invention is not limited to the foregoing example, various modifications are conceivable within the scope of the present invention.

The shape, structure, arrangement, material, and manufacturing method and the like of various members constituting the breather apparatus and the cylinder head are not limited to the above example, and may be modified accordingly.

For instance, the number and arrangement of the spaces contained in the breather apparatus are not limited to those in the above example. Specifically, for example, the blow-by gas may be introduced directly from the space 100 to the space 220 as described in the above example, or another space may be provided downstream of the space 310.

Also, the application of the engine is not limited to ATVs. The engine may be applied to, for instance, general-purpose engines for industrial or gardening use.

1. A breather apparatus that is provided in a cylinder head having an intake camshaft and an exhaust camshaft that drive an intake valve and an exhaust valve, respectively, the breather apparatus comprising:
spaces separated from each other by partition walls and in communication with each other through an opening formed in the partition walls, the spaces having a blow-by gas flowing from a crankcase side passing sequentially therethrough,
wherein the spaces include a first space formed in a region between the intake valve and the exhaust valve in the cylinder head and a second space that is provided across the first space from a crankcase side, separated from the first space by a partition wall disposed substantially along a plane including shaft centers of the intake camshaft and the exhaust camshaft, and receives the blow-by gas flowing from the first space.

2. The breather apparatus according to claim 1, wherein part of a lifter that drives the intake valve and part of a lifter that drives the exhaust valve project into the first space.

3. The breather apparatus according to claim 1, wherein the second space is provided inside a cam cover that is installed on the cylinder head and constitutes part of an intake cam chamber that houses the intake camshaft and an exhaust cam chamber that houses the exhaust camshaft.

4. The breather apparatus according to claim 1, wherein the second space is provided inside a cam cover that is installed on the cylinder head and constitutes part of an intake cam chamber that houses the intake camshaft and an exhaust cam chamber that houses the exhaust camshaft.

5. The breather apparatus according to claim 3, including a third space into which the blow-by gas from the second space flows, the third space projecting from an outer surface of the cam cover.

6. The breather apparatus according to claim 4, including a third space into which the blow-by gas from the second space flows, the third space projecting from an outer surface of the cam cover.
